(19) United States
(12) Patent Application Publication
(10) Pub. No.: US 2025/0274574 A1
(43) Pub. Date: Aug. 28, 2025

(54) METHOD AND SYSTEM FOR CORRECTING NONUNIFORMITY OF NEAR-EYE DISPLAY

(71) Applicant: JADE BIRD DISPLAY (SHANGHAI) LIMITED, SHANGHAI (CN)

(72) Inventors: Kuoyuan SUN, Shanghai (CN); Xingtong JIANG, Shanghai (CN); Jinxu WANG, Shanghai (CN)

(21) Appl. No.: 19/059,342

(22) Filed: Feb. 21, 2025

(30) Foreign Application Priority Data
Feb. 23, 2024 (WO) PCT/CN2024/078392

(51) Int. Cl. H04N 13/327; G01M 11/02; H04N 13/117; H04N 13/139; H04N 13/15

(52) U.S. Cl. CPC H04N 13/327; G01M 11/0264; H04N 13/117; H04N 13/139; H04N 13/15

(57) ABSTRACT

A method for correcting nonuniformity of a near-eye display (NED) includes: obtaining a first plurality of images in response to a first test pattern being displayed by a display of the NED, each of the first plurality of images being obtained at a different location adjacent to an end of an optical path coupled to the display; extracting a distinguishing frequency component among the first plurality of images, the distinguishing frequency component being at least caused by stray light introduced by the optical path; and determining a correction scheme for correcting nonuniformity of the NED based on the distinguishing frequency component.

### CROSS-REFERENCE TO RELATED APPLICATIONS

This disclosure claims the benefits of priority to PCT Application No. PCT/CN2024/078392, filed on Feb. 23, 2024, which is incorporated herein by reference in its entirety.

### TECHNICAL FIELD

The present disclosure generally relates to near-eye display technology, and more particularly, to a method and a system for correcting nonuniformity of a near-eye display.

### BACKGROUND

Near-eye displays (NEDs) may be provided as an augmented reality (AR) display, a virtual reality (VR) display, a Head Up/Head Mount, or other displays. Generally, an NED usually includes an image generator and optical paths including optical combiners. The image generator is commonly a projector with micro displays (e.g., micro-LED (light-emitting diode), micro-OLED (organic light-emitting diode), LCOS (liquid crystal on silicon), or DLP (digital light processing)) and an integrated optical lens. The optical combiner includes reflective and/or diffractive optics, such as freeform mirror/prism, birdbath, cascaded mirrors, or grating coupler (waveguide). A virtual image is rendered from an NED to human eyes with/without ambient light.

Uniformity is one performance factor for evaluating the imaging quality of an NED. Nonuniformity can be caused by imperfections of display pixels and optical paths to guide the light emitted by the display, and manifests as variation in global distribution, and/or variation in local zones called Mura. A visual artefact may seem like a mottled appearance, a bright spot, a black spot, or a cloudy appearance. For the NEDs such as an AR/VR display, a visual artefact is also observable on the virtual image rendered in the display system. In the virtual image rendered in the AR/VR display, nonuniformity may be shown in luminance and chromaticity. Moreover, the visual artefact caused by nonuniformity is more obvious due to the closeness to human eyes when compared with traditional displays.

Therefore, there is a need for improving the uniformity of an NED.

### SUMMARY OF THE DISCLOSURE

Embodiments of the present disclosure provide a method for correcting nonuniformity of an NED. The method includes: obtaining a first plurality of images in response to a first test pattern being displayed by a display of the NED, each of the first plurality of images being obtained at a different location adjacent to an end of an optical path coupled to the display; extracting a distinguishing frequency component among the first plurality of images, the distinguishing frequency component being at least caused by stray light introduced by the optical path; and determining a correction scheme for correcting nonuniformity of the NED based on the distinguishing frequency component.

Embodiments of the present disclosure provide a system for correcting nonuniformity of an NED. The system includes: a light measuring device (LMD) configured to: obtain a first plurality of images in response to a first test pattern being displayed by a display of the NED, each of the first plurality of images being obtained at a different location adjacent to an end of an optical path coupled to the display; and a processor configured to: extract a distinguishing frequency component among the first plurality of images, the distinguishing frequency component being at least caused by stray light introduced by the optical path; and determine a correction scheme for correcting nonuniformity of the NED based on the distinguishing frequency component.

Embodiments of the present disclosure provide a non-transitory computer-readable storage medium storing a set of instructions that are executable by one or more processors of a device to cause the device to perform operations for correcting nonuniformity of an NED, the operations including: obtaining a first plurality of images in response to a first test pattern being displayed by a display of the NED, each of the first plurality of images being obtained at a different location adjacent to an end of an optical path coupled to the display; extracting a distinguishing frequency component among the first plurality of images, the distinguishing frequency component being at least caused by stray light introduced by the optical path; and determining a correction scheme for correcting nonuniformity of the NED based on the distinguishing frequency component.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram of an exemplary system for correcting nonuniformity of an NED, according to some embodiments of the present disclosure.

FIG. 2 is a schematic diagram of an exemplary VR system according to some embodiments of the present disclosure.

FIG. 3 is a schematic diagram of an exemplary AR system according to some embodiments of the present disclosure.

FIG. 4 illustrates a flowchart of an exemplary method for correcting nonuniformity of an NED, according to some embodiments of the present disclosure.

FIG. 5 illustrates an example of a robotic arm carrying an imaging module, according to some embodiments of the present disclosure.

FIG. 6 illustrates a flowchart of sub-steps of the exemplary method for correcting nonuniformity of an NED shown in FIG. 4, according to some embodiments of the present disclosure.

FIG. 7 illustrates an example of a moving direction of a robotic arm carrying an imaging module, according to some embodiments of the present disclosure.

FIG. 8 illustrates an example of images captured by an imaging module for determining a central location of an eyebox of a display, according to some embodiments of the present disclosure.

FIG. 9 illustrates an example of locations for an imaging module for capturing images, according to some embodiments of the present disclosure.

FIG. 10 illustrates a flowchart of sub-steps of the exemplary method for correcting nonuniformity of an NED shown in FIG. 4, according to some embodiments of the present disclosure.

FIG. 11 illustrates an example of intermediate images according to some embodiments of the present disclosure.

FIG. 12 illustrates an example of distinguishing frequency components according to some embodiments of the present disclosure.

FIG. 13 illustrates a flowchart of sub-steps of the exemplary method for correcting nonuniformity of an NED shown in FIG. 4, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

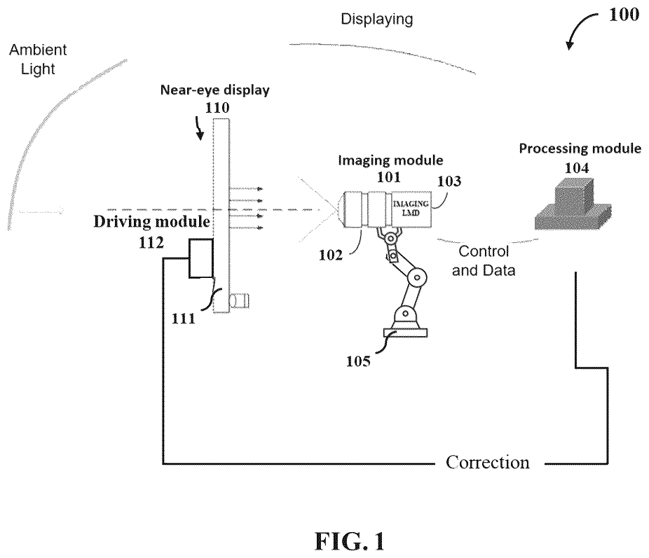

FIG. 1 is a schematic diagram of an exemplary system 100 for correcting nonuniformity of an NED, according to some embodiments of the present disclosure. As shown in FIG. 1, system 100 is used for correcting nonuniformity of an NED 110. Typically, NED 110 is used for displaying images to human eyes, and NED 110 can be included in an AR device or a VR device, such as a Head-Up/Head-Mount display, a projector, or other displays. In the present disclosure, system 100 is provided for replacing human eyes to evaluate the imaging quality of NED 110 and correct potential nonuniformity accordingly.

In some embodiments, NED 110 includes an image generator 111. Image generator 111 is provided as one or more micro displays (e.g., one display for one eye), such as micro-LED displays, micro-OLED displays, LCOS displays, or DLP displays, and each of the micro displays can be configured as a light engine with an additional projector lens. In some embodiments, the display may be coupled with a plurality of lenses (also referred to as a “lens group”, “designed optics”, etc.) for adjusting the image displayed by the micro display in a manner applicable to human eyes. The micro display of image generator 111 includes a micro light emitting array which can form an active emitting area. The projected image from the light engine through designed optics is transferred to human eyes via an optical path including an optical combiner (not shown). The optics of the optical combiner can be reflective and/or diffractive optics, such as a free form mirror/prism, birdbath, or cascaded mirrors, grating coupler (waveguide), etc.

In some embodiments, a driving module 112, for example, a driver, can be further provided to drive NED 110 for image displaying. Driving module 112 can be coupled to communicate with NED 110, specifically to communicate with image generator 111 of NED 110. That is, driving module 112 can be configured to drive image generator 111 to display an image on the micro displays by driving signals.

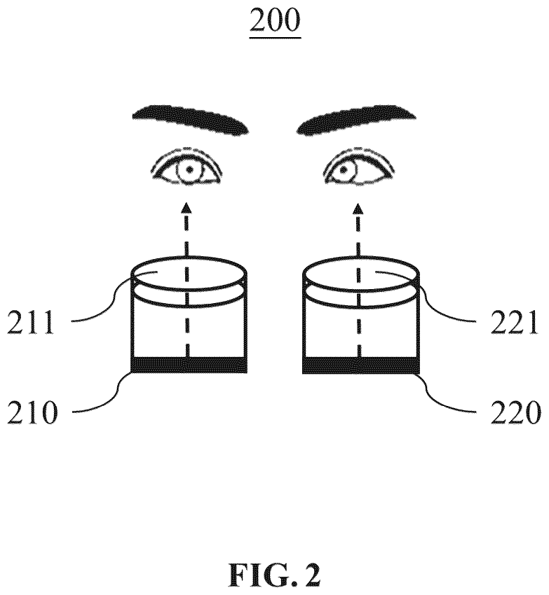

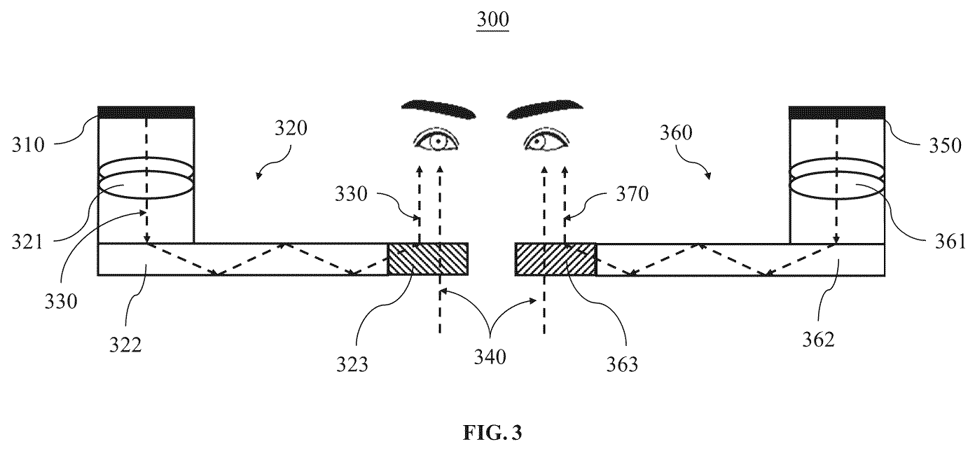

FIG. 2 is a schematic diagram of an exemplary VR system 200 and FIG. 3 is a schematic diagram of an exemplary AR system 300, according to some embodiments of the present disclosure. Referring to FIG. 2, VR system 200 includes a first micro display 210 (e.g., a right display) and a corresponding lens group 211 for adjusting (e.g., magnifying) the image displayed by first micro display 210 in a manner applicable to a viewer's right eye. Similarly, VR system 200 also includes a second micro display 220 (e.g., a left display) and a corresponding lens group 221 for adjusting the image displayed by second micro display 220 in a manner applicable to a viewer's left eye.

It is to be noted that “left” and “right” mentioned in the present disclosure are from the perspective view from a person (i.e., a user or a viewer of system 200) shown in FIG. 2. In the present disclosure, the light path from a micro display to a human eye is also called an optical path, which can include several optical components. That is, lens group 211 and lens group 221 are within respective optical paths and are deemed as optical components of their respective optical paths.

As can be appreciated, first micro display 210 can be used to display a right image, while second micro display 220 can be used to display a left image captured or rendered at a different angle from the right image. When simultaneously viewing the left image and right image, the brain of the viewer combines these two images into a three-dimensional scene. However, if the uniformity within either the left image or the right image is not ideal, a “sense of place” of the three-dimensional scene created by these two images can be affected. The nonuniformity can be caused by one or more of second micro display 220, first micro display 210, lens group 211, or lens group 221. For example, when driven by a signal indicating a same intensity of brightness, some display pixels in either or both of first micro display 210 and second micro display 220 may be brighter compared with the others. The wavelengths of the three fundamental colors emitted by the display pixels are different, such that the propagation properties in the optical paths thereof are different, which may cause nonuniformity in the images rendered by VR system 200 to human eyes. In addition, some stray light can be introduced by the optical paths, which should be considered when determining the propagation property of an optical path.

Referring to FIG. 3, AR system 300 includes a first micro display 310 (e.g., a right display) and its corresponding optical path 320 for passing the image displayed by first micro display 310 to the right eye of the viewer. As can be seen, optical path 320 includes a lens group 321, a waveguide 322, and an optical combiner 323. Lens group 321 is configured to adjust the image displayed by first micro display 310. Waveguide 322 can be used for directing light 330 emitted from first micro display 310 by several total reflections. Optical combiner 323 directs light 330 emitted from first micro display 310 and may allow ambient light 340 to pass through. Hence, both light 330 and ambient light 340 can reach the right eye of the viewer, and the viewer sees an image to be superimposed on an environment scene. Similarly, AR system 300 also includes a second micro display 350 (e.g., a left display) and its corresponding optical path 360 for passing the image displayed by second micro display 350 to the left eye. Typically, second micro display 350 is of the same resolution as first micro display 310. Optical path 360 includes a lens group 361, a waveguide 362, and an optical combiner 363. As can be appreciated, the viewed images can be affected by anything between the displays and human eyes. That is, the viewed images can be affected by one or more of first micro display 310, second micro display 350, optical path 320, or optical path 360. As described above, the nonuniformity of AR system 300 may be caused by optical path 320 or optical path 360 which may absorb different color components at different intensities. Color cast may occur in the images rendered by AR system 300 to human eyes. When a nonuniformity exists in the viewed images, the imaging effect of AR system 300 deteriorates. In addition, some stray light can be introduced by optical path 320 or optical path 360, which should be eliminated or reduced when determining the propagation property of optical path 320 or optical path 360.

Referring back to FIG. 1, system 100 includes an imaging module 101, for example, an imager, a processing module 104, for example, a processor, and a robotic arm 105. Imaging module 101 is configured to emulate the human eye to measure display optical characteristics and to observe display performance. In some embodiments, imaging module 101 can include a lens 102 and a light measuring device (LMD) 103. For example, LMD 103 can be a colorimeter or an imaging camera, such as a CCD (charge coupled device) or a CMOS (complementary metal oxide semiconductor) image sensor. Lens 102 can be an NED lens or normal lens, according to an absolute or relative value measure. Lens 102 of imaging module 101 is provided with a front aperture having a small diameter of, e.g., 1 mm-6 mm. Lens 102 can provide a wide FOV (Field of View) in front, and lens 102 is configured to emulate a human eye to observe NED 110. The optical properties of a virtual image displayed by NED 110 are captured by imaging module 101 and measured by processing module 104.

Processing module 104 is configured to evaluate and improve the uniformity of the virtual image rendered by NED 110. In some embodiments, processing module 104 can be included in a computer or a server. In some embodiments, processing module 104 can be deployed in the cloud, which is not limited herein. In some embodiments, processing module 104 can include one or more processors.

Robotic arm 105 is configured to carry imaging module 101. In some embodiments of the present disclosure, robotic arm 105 is alternatively described as carrying LMD 103, which is technically the same. Robotic arm 105 may have five degrees of freedom of movement, i.e., horizontal translation, vertical translation, pitch, yaw, and roll. In this manner, imaging module 101 carried by robotic arm 105 can move relatively with an end of an optical path (not shown) coupled to image generator 111. Thus, imaging module 101 can capture images rendered by image generator 111 at different locations.

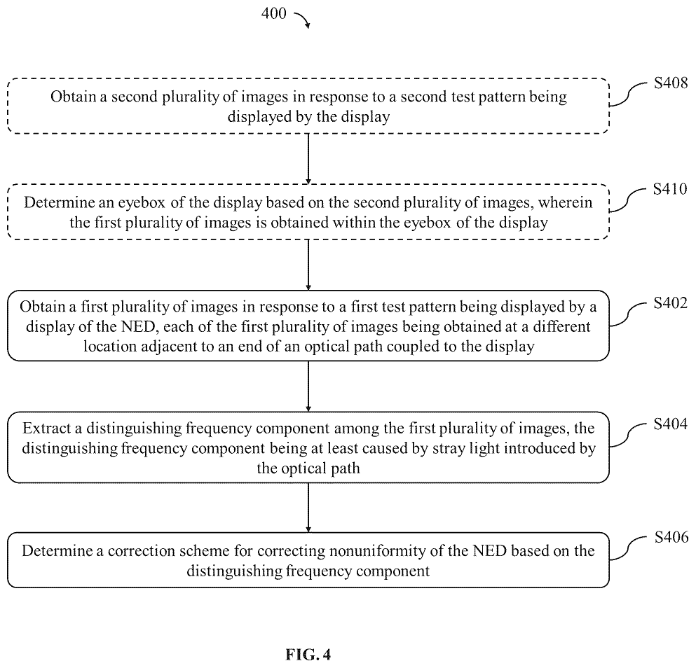

FIG. 4 illustrates a flowchart of an exemplary method 400 for correcting nonuniformity of an NED, according to some embodiments of the present disclosure. The NED can be either a VR system or an AR system as described above with reference to FIGS. 2 and 3, respectively, and the display can be either the first micro display or the second micro display described above. Method 400 includes steps S402 to S406 and optional steps S408 and S410, which can be implemented by a uniformity correcting system (such as system 100 in FIG. 1).

At step S402, a first plurality of images is obtained in response to a first test pattern being displayed by a display of the NED, wherein each of the first plurality of images can be obtained at a different location adjacent to an end of an optical path coupled to the display. For example, with further reference to FIG. 3, an imaging module (e.g., imaging module 101 in FIG. 1) can be disposed adjacent to the end of optical path 320 to capture the right images corresponding to the displayed test patterns displayed by first micro display 310. In the present disclosure, the imaging module can be disposed at a distance similar to that between an eye and optical combiner 323 of AR system 300. “Adjacent to the end” or “at the end” implies that the imaging module is disposed spaced from the end of the optical path and can obtain a full image such as an eye could see. In other words, the imaging module may not be disposed in contact with the end of the optical path. As described above, imaging module 101 can be carried by robotic arm 105 to move in five degrees of freedom. To measure a distinguishing property of images viewed from different directions, imaging module 101 may obtain images at different locations adjacent to the end of the optical path. In some embodiments, one imaging module can be used to capture the left (or right) image and then the right (or left) image.

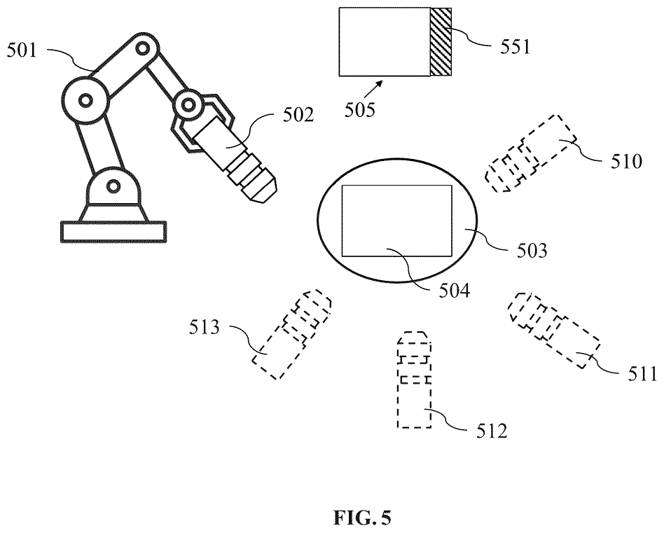

FIG. 5 illustrates an example of a robotic arm 501 carrying an imaging module 502, according to some embodiments of the present disclosure. Robotic arm 501 and imaging module 502 generally correspond to robotic arm 105 and imaging module 101, respectively, in FIG. 1. Imaging module 502 can be moved by robotic arm 501 in five degrees of freedom, i.e., horizontal translation, vertical translation, pitch, yaw, and roll. As shown in FIG. 5, imaging module 502 can be moved relative to an end of an optical path 503 coupled to an image generator (not shown), while its aiming direction can be towards the end of optical path 503. A virtual image 504 of a first pattern can be seen by a human eye or captured by imaging module 502. As such, the first plurality of images of the first test pattern can be captured by imaging module 502 from different locations at different angles. For example, imaging module 502 can be carried by robotic arm 501 and moved to traverse locations 510, 511, 512, 513, etc. in sequence. Every time imaging module 502 is moved to a designated location, for example, locations 510, 511, 512, or 513, it can capture an image so as to collect the first plurality of images in a first plurality of locations. In this process, imaging module 502 can be located in different locations to simulate human eyes viewing from different locations.

Referring back to FIG. 4, before step S402, method 400 may further include optional steps S408 and S410 for determining an eyebox of the display. In near-eye display systems, one factor in determining the user experience is the size of the eyebox. The eyebox refers to a volume where the eye receives an acceptable view of the image with respect to a set of criteria and thresholds. For example, human eyes can receive a complete image rendered by AR system 300 shown in FIG. 3 within an eyebox of AR system 300.

At optional step S408, in response to a second test pattern being displayed by the display, a second plurality of images is obtained. The second test pattern can be the same as or different from the first test pattern. Although it may be not emphasized in other places of this disclosure, both the first and the second plurality of images are captured using robotic arm 501. For example, imaging module 502 shown in FIG. 5 can be moved by robotic arm 501 along a designated route. In a simplified example, imaging module 502 can be moved in horizontal and vertical directions based on the designated route, which can cover the eyebox of the display. The designed route is based on past experience to ensure it covers the eyebox.

At step S410, an eyebox of the display is determined based on the second plurality of images, wherein the first plurality of images is obtained within the eyebox of the display at step S402. By capturing a sequence of images while moving according to the designated route, imaging module 502 shown in FIG. 5 can determine the eyebox of the display in which a complete image is obtained from the sequence of images. For example, as shown in FIG. 5, virtual image 504 can be captured as one of the complete images with no parts missing. As a comparison, an image 505 of the first test pattern is an incomplete images that is partially outside the eyebox of the display and, accordingly, its right part 551 is missing.

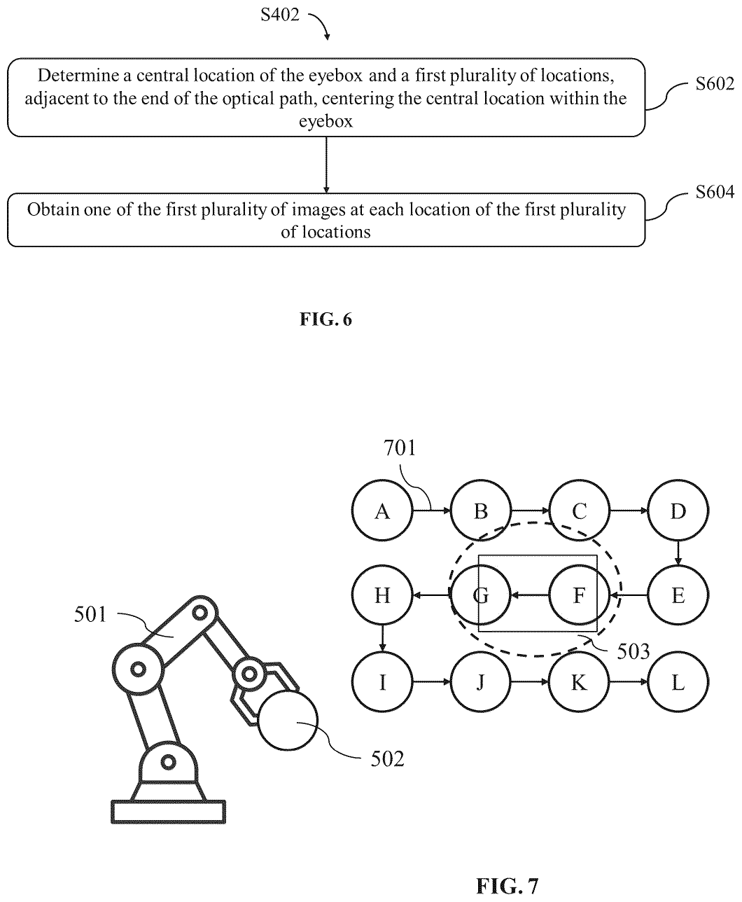

FIG. 6 illustrates a flowchart of sub-steps of method 400 for correcting nonuniformity of an NED, according to some embodiments of the present disclosure. As shown in FIG. 6, step S402 includes sub-steps S602 and S604.

At sub-step S602, a central location of the eyebox and a first plurality of locations, adjacent to the end of the optical path, centering the central location within the eyebox are determined. FIG. 7 illustrates an example of a moving direction 701 of robotic arm 501 carrying imaging module 502, according to some embodiments of the present disclosure. In a simplified example, imaging module 502 can be moved in horizontal and vertical directions by robotic arm 501. According to moving direction 701, imaging module 502 can traverse locations A, B, C, . . . , L in sequence. Every time imaging module 502 is moved to a designated location, for example, locations A, B, C, . . . , or L, it captures an image.

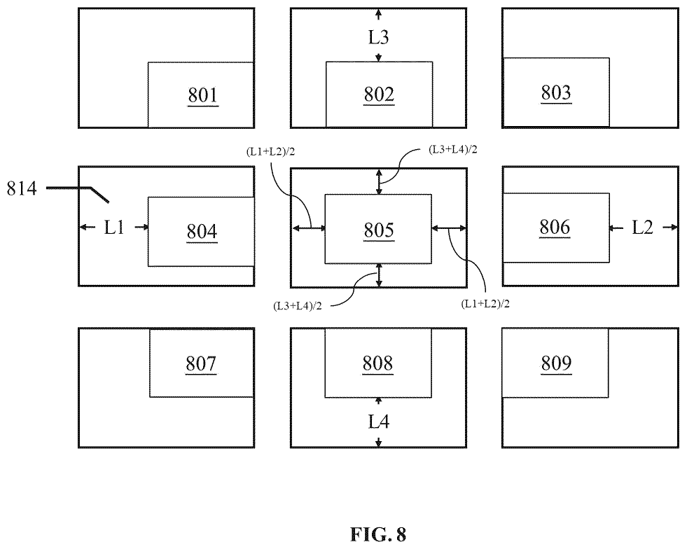

FIG. 8 illustrates an example of images 801 to 809 captured by imaging module 502, shown in FIGS. 5 and 7, for determining a central location of an eyebox of a display, according to some embodiments of the present disclosure. As shown in FIG. 8, images 801 to 809 are captured by imaging module 502 within the eyebox of the display at different locations, such that images 801 to 809 are still within the imaging area of imaging module 502, and each of images 801-809 can illustrate a whole test pattern displayed by the display. Specifically, when imaging module 502 moves to an upper left corner of the eyebox, the captured image 801 will be present at a lower right corner of an imaging area of imaging module 502. Similarly, with imaging module 502 moving to an upper right corner, a lower left corner, and a lower right corner of the eyebox, the captured images 803, 807 and 809 will be present at a lower left corner, an upper right corner, and an upper left corner of the imaging area of imaging module 502, respectively. In addition, when imaging module 502 moves to a left edge of the eyebox, a captured image 804 will be present at a right side of an imaging area 814 of imaging module 502, and its left edge is at distance L1 from a left side of the imaging area of imaging module 502. Similarly, with imaging module 502 moving to a right edge, an upper edge, and a lower edge of the eyebox, the captured images 806, 802 and 808 will be in a left side, a lower side, and an upper side of the imaging area of imaging module 502, respectively. A right edge of image 806 is at a distance L2 from a right side of the imaging area of imaging module 502, an upper edge of image 802 is at a distance L3 from an upper side of the imaging area of imaging module 502, and a lower edge of image 808 is at a distance L4 from a lower side of the imaging area of imaging module 502. In a simplified example, when imaging module 502 captures image in the central location of an eyebox, a captured image 805 will be present centered in the imaging area of imaging module 502 with its left and right edges at a distance (L1+L2)/2 from the left and right sides of the imaging area of imaging module 502, respectively. Meanwhile, the upper and lower edges of image 805 are at a distance (L3+L4)/2 from the upper and lower sides of the imaging area of imaging module 502, respectively. The determined position of image 805 in the imaging area of imaging module 502 can be reflected in a spatial location of the imaging module 502 relative to the end of the optical path, which can be deemed as the central location of the eyebox of the display.

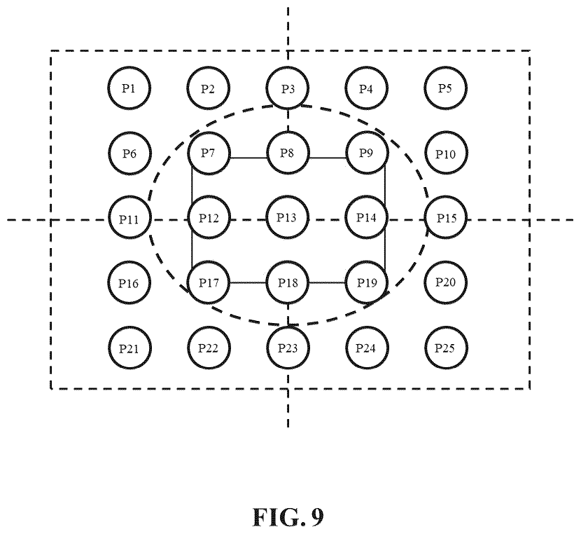

FIG. 9 illustrates an example of locations P1 to P25 for imaging module 502, shown in FIGS. 5 and 7, for capturing images, according to some embodiments of the present disclosure. When the central location of the eyebox is determined, the first plurality of locations, adjacent to the end of the optical path, centering the central location within the eyebox can be determined accordingly. For example, as shown in FIG. 9, twenty five locations P1 to P25 centering a central location P13 within the eyebox can be determined for capturing images. It is noted that location P13 is also regarded as centering central location P13. Among all the locations P1 to P25, a horizontal or vertical distance between two adjacent locations can be the same, and can be for example several millimeters to tens of millimeters.

Referring back to FIG. 6, at sub-step S604, one of the first plurality of images is obtained at each location of the first plurality of locations. For example, each of the first plurality of images can be obtained in a location from the locations P1, P2, . . . , P24, or P25 shown in FIG. 9. In this way, the plurality of images can be collected in a uniform manner, which may benefit a following step S404 in which some of the properties of these images are extracted.

Referring back to FIG. 4, at step S404, a distinguishing frequency component among the first plurality of images is extracted, wherein the distinguishing frequency component is at least caused by stray light introduced by the optical path. A general concept herein is that when the same image is guided through the optical path and viewed from different locations adjacent to the end the optical path, and therefore at different angles, the stray light introduced by the optical path renders the images viewed from the different angles different, which is an inherent property of the optical path. As appreciated, the first plurality of images can be processed and transformed into an analytical domain (e.g., a frequency domain) in which the frequency component can be extracted for each of these images, and a distinguishing frequency component or distinguishing frequency components thereof can be determined accordingly.

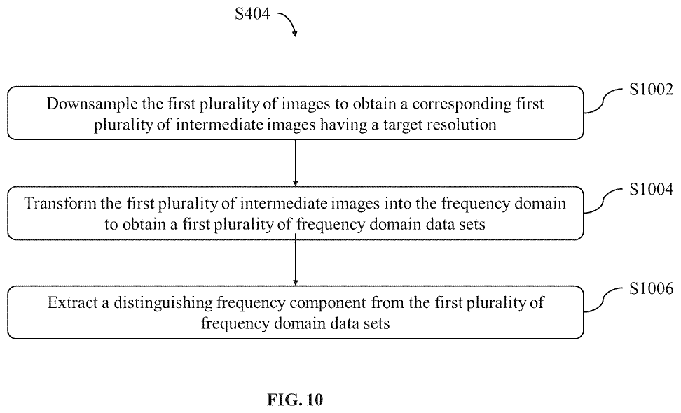

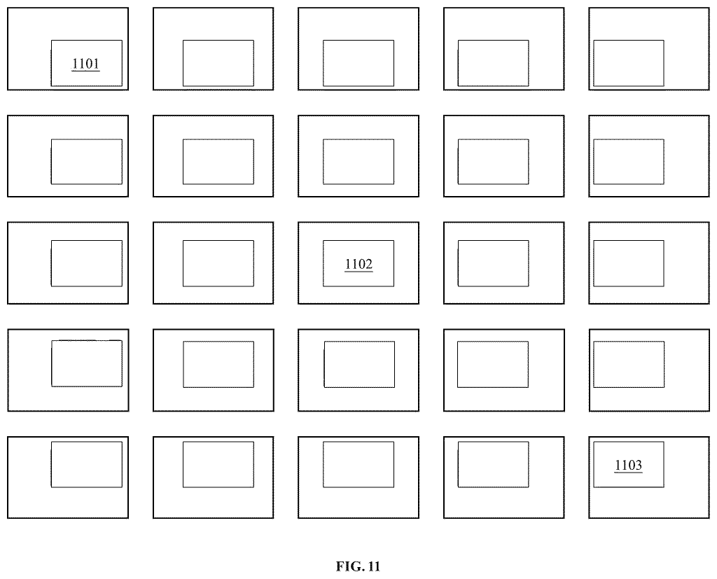

FIG. 10 illustrates a flowchart of sub-steps of the exemplary method for correcting nonuniformity of an NED shown in FIG. 4, according to some embodiments of the present disclosure. As shown in FIG. 10, step S404 includes sub-steps S1002 and S1006.

At sub-step S1002, the first plurality of images is downsampled to obtain a corresponding first plurality of intermediate images having a target resolution. The images captured by the imaging module may have a fine resolution (e.g., 9000×6000), which may be too large for image processing. In some embodiments, the resolution of these images can be lowered by pixel decimation. As used herein, pixel decimation refers to a process by which the number of image pixels in an image is reduced, e.g., downsampled. For example, with further reference to FIG. 3, the target resolution can be set equal to a display resolution of first micro display 310 (or second micro display 350), such as 640×480. In an example, 640×480 pixels out of 9000×6000 pixels from an image are selected to represent the image, which is called an intermediate image. For example, the 9000×6000 pixels are decimated, i.e., reduced in number, in a uniform manner both in the horizontal and vertical directions. In some other examples, the images are scaled in a manner such that a representative pixel is the average of its nearest neighboring pixels.

At sub-step S1004, the first plurality of intermediate images is transformed into the frequency domain to obtain a first plurality of frequency domain data sets. FIG. 11 illustrates an example of intermediate images 1101, 1102, 1103, etc. according to some embodiments of the present disclosure. The first plurality of images and the first plurality of intermediate images are represented by grayscale values. As shown in FIG. 11, twenty five images are obtained with respect to the different locations in FIG. 9 and downsampled to form the intermediate images as illustrated, wherein each of the images may be present in a different location of the imaging area of the imaging module. In some embodiments, the first plurality of intermediate images can be transformed into the frequency domain by Fast Fourier Transform or wavelet transform. As appreciated, although both of the transforming results are called frequency domain data sets, they can be different due to the different mathematical expressions in Fast Fourier Transform and wavelet transform.

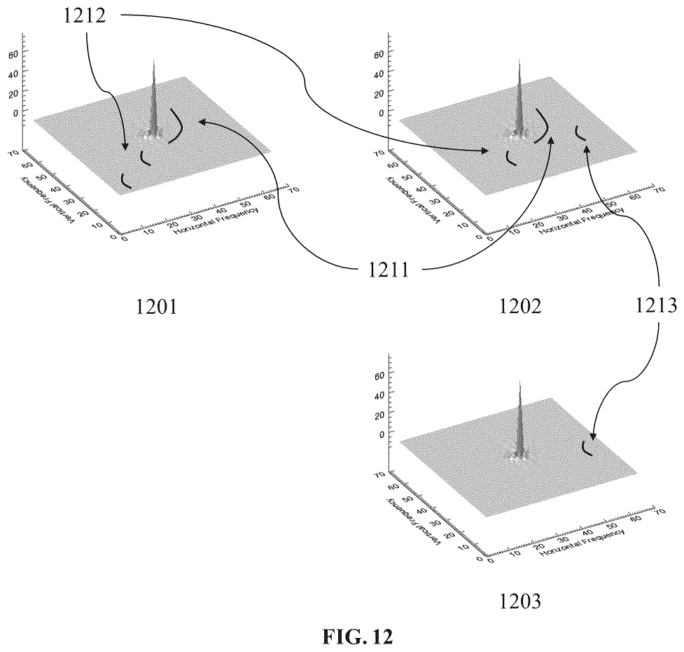

Referring back to FIG. 10, at sub-step S1006, a distinguishing frequency component is extracted from the first plurality of frequency domain data sets. FIG. 12 illustrates an example of distinguishing frequency components 1211, 1212, and 1213 according to some embodiments of the present disclosure. In some embodiments, the distinguishing frequency component may include more than one distinguishing frequency component. As shown in FIG. 12, frequency domain data sets transformed from two intermediate images 1101 and 1102 in FIG. 11, for example, are represented by images 1201 and 1202. Images 1201, 1202, and 1203 are represented in a coordinate system with an x-axis of horizontal frequency in the frequency domain, a y-axis of vertical frequency in the frequency domain, and a z (vertical) axis of intensity of these frequencies. The intensity can be expressed in terms of dimensions without units. Among the frequency components shown in images 1201 and 1202, the differences therebetween are referred to as distinguishing frequency components 1211 and 1212 shown as black curves, which may be caused by the optical paths. The distinguishing frequency components of a certain location among the locations can remain unchanged regardless of what image is rendered on the display. That is, the distinguishing frequency components for a certain location, for example location P13 shown in FIG. 9 can be the same when different images are presented by the display. As such, the pre-determined distinguishing frequency components for a certain location can be used to reduce the impact caused by the stray light.

Referring back to FIG. 4, at step S406, a correction scheme is determined for correcting nonuniformity of the NED based on the distinguishing frequency component, or the plural distinguishing frequency components in some examples. In some embodiments, the pre-determined distinguishing frequency components for a certain location can be removed according to the correction scheme, thus the nonuniformity introduced by the stray light can be reduced. In some embodiments, a plurality of test patterns with different grayscale values can be introduced for determining the distinguishing frequency components, and method 400 can be performed according to each of the test patterns. In this way, the extracted distinguishing frequency component(s) for a certain location can be more accurate to reflect the transmitting properties of the optical path, thus minimizing the impact of accidental errors.

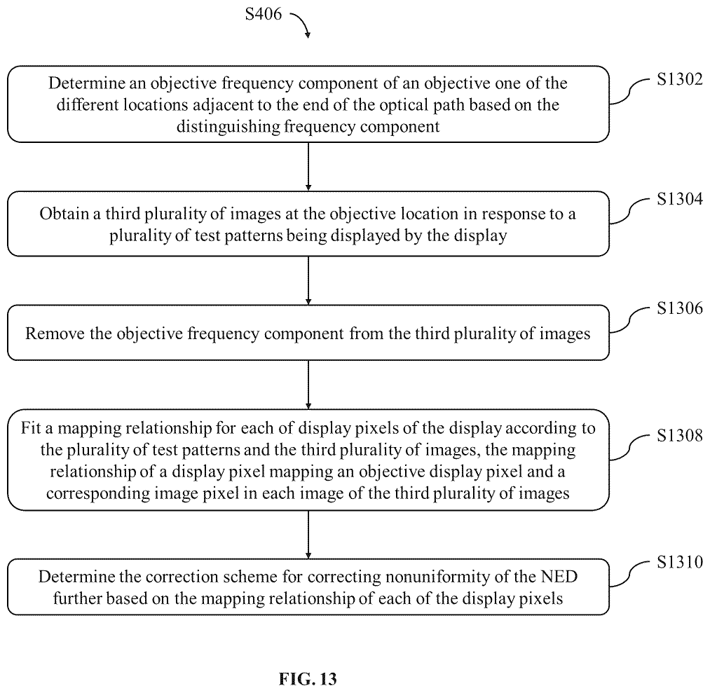

FIG. 13 illustrates a flowchart of sub-steps of the exemplary method 400 for correcting nonuniformity of an NED shown in FIG. 4, according to some embodiments of the present disclosure. As shown in FIG. 13, step S406 may further include sub-steps S1302 to S1310.

At sub-step S1302, an objective frequency component of an objective one of the different locations adjacent to the end of the optical path is determined based on the distinguishing frequency component, or the plural distinguishing frequency components in some examples. For example, with further reference to FIGS. 11 and 12, frequency domain data sets transformed from two intermediate images 1102 and 1103 are represented by images 1202 and 1203. Among the frequency components shown in images 1202 and 1203, the difference therebetween is referred to as distinguishing frequency component 1213 shown as a black curve. To this end, the objective frequency components of location P13, i.e., the location to generate intermediate image 1102, include distinguishing frequency components 1211, 1212 and 1213. In a simplified example, intermediate image 1102 does not possess other distinguishing frequency components when compared with other intermediate images. As such, the objective frequency components of location P13 are distinguishing frequency components 1211, 1212 and 1213.

At sub-step S1304, a third plurality of images is obtained at the objective location in response to a plurality of test patterns being displayed by the display. Continuing with the example described above, the third plurality of images can be obtained at location P13. Each of the third plurality of images corresponds to a test pattern. For example, with further reference to FIGS. 3 and 9, an imaging module (e.g., imaging module 101 in FIG. 1) can be disposed at the end of optical path 320 at location P13 to capture the right images corresponding to the displayed test patterns shown by first micro display 310. In the present disclosure, the imaging module can be disposed at location P13 at a distance similar to that between an eye and optical combiner 323 of AR system 300.

At sub-step S1306, the objective frequency component is removed from the third plurality of images. As described above, the distinguishing frequency components of location P13 can be kept the same regardless of what image is rendered on the display. The predetermined distinguishing frequency components can be removed to obtain a “clean” image without affects from the stray light.

At sub-step S1308, a mapping relationship is fitted for each of display pixels of the display according to the plurality of test patterns and the third plurality of images, wherein the mapping relationship between a display pixel maps the objective display pixel and a corresponding image pixel in each image of the third plurality of images. The mapping relationship of an objective display pixel (e.g., any display pixel in the display) maps the objective display pixel to a corresponding image pixel in each image of the third plurality of images. For example, if the number of test patterns and the corresponding number of images are N, then the mapping relationship of the objective display pixel can map the objective display pixel displayed in N test patterns to N corresponding image pixels, and each image pixel resides in an image. Alternatively, the resolution of the images can be higher than the display resolution, so that the objective display pixel may be mapped to more than one image pixel within an image by the mapping relationship. In this situation, a representative pixel can be selected from these image pixels.

At sub-step S1310, the correction scheme is determined for correcting nonuniformity of the NED further based on the mapping relationship of each of the display pixels. It is appreciated that the mapping relationship in the present disclosure is generated according to several test patterns, so the electrical characteristics of the display pixels are measured in a more reliable way compared with traditional ones. Hence, the correction scheme based on the mapping relationship will reflect the actual performance of different display pixels. In this way, the correction scheme herein can reduce the nonuniformity introduced by stray light and the electrical characteristics of the display pixels.

In some embodiments, the display of the NED includes a driver to drive display of an image, and method 400 may include the step of updating the driver of the display according to the correction scheme. In some embodiments, the determined correction scheme can be saved for further processing. For example, when a display pixel of the display is driven by a signal

$$[ \begin{matrix}{r}_{in} \\ {g}_{in} \\ {b}_{in}\end{matrix} ]$$

in RGB chroma space, the updated drives can correct this driving signal to

$$[ \begin{matrix}{r}_{out} \\ {g}_{out} \\ {b}_{out}\end{matrix} ] = {[ {M}_{3 \times 3} ]}_{corr} \times [ \begin{matrix}{r}_{in} \\ {g}_{in} \\ {b}_{in}\end{matrix} ] ,$$

which is actually used to drive the display pixel, wherein [M_{3×3}]_{corr} is a correction matrix based on the correction scheme.

Some embodiments of the present disclosure further provide a non-transitory computer-readable storage medium storing a set of instructions that are executable by one or more processors of a device to cause the device to perform any of the above-mentioned methods for correcting nonuniformity of an NED.

It should be noted that relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequences of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method for correcting nonuniformity of a near-eye display (NED), comprising:
obtaining a first plurality of images in response to a first test pattern being displayed by a display of the NED, each of the first plurality of images being obtained at a different location adjacent to an end of an optical path coupled to the display;
extracting a distinguishing frequency component among the first plurality of images, the distinguishing frequency component being at least caused by stray light introduced by the optical path; and
determining a correction scheme for correcting nonuniformity of the NED based on the distinguishing frequency component.

2. The method according to claim 1, further comprising:
obtaining a second plurality of images in response to a second test pattern being displayed by the display; and
determining an eyebox of the display based on the second plurality of images;
wherein the first plurality of images is obtained within the eyebox of the display.

3. The method according to claim 2, wherein obtaining the first plurality of images in response to the first test pattern being displayed by the display of the NED comprises:
determining a central location of the eyebox and a first plurality of locations, adjacent to the end of the optical path, centering the central location within the eyebox; and
obtaining one of the first plurality of images at each location of the first plurality of locations.

4. The method according to claim 1, wherein extracting the distinguishing frequency component among the first plurality of images comprises:
downsampling the first plurality of images to obtain a corresponding first plurality of intermediate images having a target resolution;
transforming the first plurality of intermediate images into a frequency domain to obtain a first plurality of frequency domain data sets; and
extracting the distinguishing frequency component from the first plurality of frequency domain data sets.

5. The method according to claim 4, wherein the target resolution is equal to a display resolution of the display.

6. The method according to claim 4, wherein the first test pattern comprises a plurality of test patterns with different grayscale values.

7. The method according to claim 4, wherein the first plurality of images and the first plurality of intermediate images are represented by grayscale values.

8. The method according to claim 4, wherein the first plurality of intermediate images is transformed into the frequency domain by Fast Fourier Transform or wavelet transform.

9. The method according to claim 1, wherein determining the correction scheme for correcting nonuniformity of the NED comprises:
determining an objective frequency component of an objective one of the different locations adjacent to the end of the optical path based on the distinguishing frequency component;
obtaining a second plurality of images at an objective location in response to a second plurality of test patterns being displayed by the display;
removing the objective frequency component from the second plurality of images;
fitting a mapping relationship for each of display pixels of the display according to the second plurality of test patterns and the second plurality of images, the mapping relationship of a display pixel mapping an objective display pixel and a corresponding image pixel in each image of the second plurality of images; and
determining the correction scheme for correcting nonuniformity of the NED further based on the mapping relationship of each of the display pixels.

10. The method according to claim 9, wherein the display comprises a driver to drive display of an image, the method further comprising:
updating the driver of the display according to the correction scheme.

11. A system for correcting nonuniformity of a near-eye display (NED), comprising:
a light measuring device (LMD) configured to:
obtain a first plurality of images in response to a first test pattern being displayed by a display of the NED, each of the first plurality of images being obtained at a different location adjacent to an end of an optical path coupled to the display; and
a processor configured to:
extract a distinguishing frequency component among the first plurality of images, the distinguishing frequency component being at least caused by stray light introduced by the optical path; and
determine a correction scheme for correcting nonuniformity of the NED based on the distinguishing frequency component.

12. The system according to claim 11, wherein the LMD is further configured to obtain a second plurality of images in response to a second test pattern being displayed by the display, and obtain the first plurality of images within an eyebox of the display; and
the processor is further configured to determine the eyebox of the display based on the second plurality of images.

13. The system according to claim 12, wherein the processor is further configured to determine a central location of the eyebox and a first plurality of locations, adjacent to the end of the optical path, centering the central location within the eyebox; and
the LMD is further configured to obtain one of the first plurality of images at each location of the first plurality of locations.

14. The system according to claim 11, wherein the processor is further configured to:
downsample the first plurality of images to obtain a corresponding first plurality of intermediate images having a target resolution;
transform the first plurality of intermediate images into a frequency domain to obtain a first plurality of frequency domain data sets; and
extract the distinguishing frequency component from the first plurality of frequency domain data sets.

15. The system according to claim 14, wherein the target resolution is equal to a display resolution of the display.

16. The system according to claim 14, wherein the first test pattern comprises a plurality of test patterns with different grayscale values.

17. The system according to claim 14, wherein the first plurality of images and the first plurality of intermediate images are represented by grayscale values.

18. The system according to claim 14, wherein the processor is further configured to transform the first plurality of intermediate images into the frequency domain by Fast Fourier Transform or wavelet transform.

19. The system according to claim 11, wherein,
the LMD is further configured to:
obtain, in response to a second plurality of test patterns being displayed by the display, a second plurality of images at an objective one of the different locations adjacent to the end of the optical path; and
the processor is further configured to:
determine an objective frequency component of an objective location based on the distinguishing frequency component;
remove the distinguishing frequency component from the second plurality of images;
fit a mapping relationship for each of display pixels of the display according to the second plurality of test patterns and the second plurality of images, the mapping relationship of a display pixel mapping an objective display pixel and a corresponding image pixel in each image of the second plurality of images; and
determine the correction scheme for correcting nonuniformity of the NED further based on the mapping relationship of each of the display pixels.

20. A non-transitory computer-readable storage medium storing a set of instructions that are executable by one or more processors of a device to cause the device to perform operations for correcting nonuniformity of a near-eye display (NED), the operations comprising:
obtaining a plurality of images in response to a first test pattern being displayed by a display of the NED, each of the plurality of images being obtained at a different location adjacent to an end of an optical path coupled to the display;
extracting a distinguishing frequency component among the plurality of images, the distinguishing frequency component being at least caused by stray light introduced by the optical path; and
determining a correction scheme for correcting nonuniformity of the NED based on the distinguishing frequency component.
